(19) United States
(12) Patent Application Publication
(10) Pub. No.: US 2019/0355286 A1
(43) Pub. Date: Nov. 21, 2019

(54) FLAG-MOUNTING BRACE

(71) Applicant: Tammy French, Oklahoma City, OK (US)

(72) Inventor: Tammy French, Oklahoma City, OK (US)

(21) Appl. No.: 16/415,971

(22) Filed: May 17, 2019

Related U.S. Application Data
(60) Provisional application No. 62/673,159, filed on May 18, 2018.

(51) Int. Cl. G09F 17/00; F16M 13/02

(52) U.S. Cl. CPC G09F 17/00; G09F 2017/0083; F16M 13/022

(57) ABSTRACT

A flag mounting brace, including a horizontal brace, a first anchor disposed on a first end of the horizontal brace to removably connect to at least a portion of a sign, and a second anchor disposed on a second end of the horizontal brace to removably connect to at least another portion of the sign.

### CROSS REFERENCE TO RELATED APPLICATION

This application claims the benefit of, and incorporates by reference, U.S. provisional patent application Ser. No. 62/673,159, entitled “A Flag-Mounting Brace,” which was filed on May 18, 2018.

### BACKGROUND

### 1. Field

The present general inventive concept relates generally to a brace, and particularly, to a brace that is used to mount a flag on a road sign.

### 2. Description of the Related Art

Many times, during road construction the workers post signs to warn oncoming traffic of construction ahead. Further signage is used to divert traffic as needed as workers may be performing construction on the roadway and therefore will need divert traffic to avoid accidents. The road signs in addition to being posted proving obstruction as to traffic moving frequently include flags that are placed on a sign or onto a pole holding the sign to provide further attention to the instruction. Unfortunately, these flags are often blown out of place or unable to be secured to the sign properly. As a result, it would be advantageous to have a device specifically designed to mount flags on construction road signs that could hold the flags in place.

### SUMMARY

The present general inventive concept provides a flag mounting brace.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a flag mounting brace, including a horizontal brace, a first anchor disposed on a first end of the horizontal brace to removably connect to at least a portion of a sign, and a second anchor disposed on a second end of the horizontal brace to removably connect to at least another portion of the sign.

The horizontal brace may deform at least partially in response to a force applied thereupon.

The horizontal brace may prevent a flag from falling in response to insertion of the flag between the sign and the horizontal brace.

The first anchor may deform at least partially in response to a force applied thereupon.

The second anchor may deform at least partially in response to a force applied thereupon.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a zoomed-in view of a flag-mounting brace, according to an exemplary embodiment of the present general inventive concept; and

FIG. 2 illustrates a side perspective view of the flag-mounting brace disposed around on a flag as disposed against a surface, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Flag-Mounting Brace 50
First Anchor 10
Second Anchor 12
Horizontal Brace 15

The present invention relates to a flag-mounting brace that is used to mount flags onto a construction road sign. The mounting brace includes a first anchor and a second anchor with a horizontal brace extending between thereto. The mounting anchors flexibly insert into holes of the road sign and allow for the placement of flag between the mounting brace and the sign.

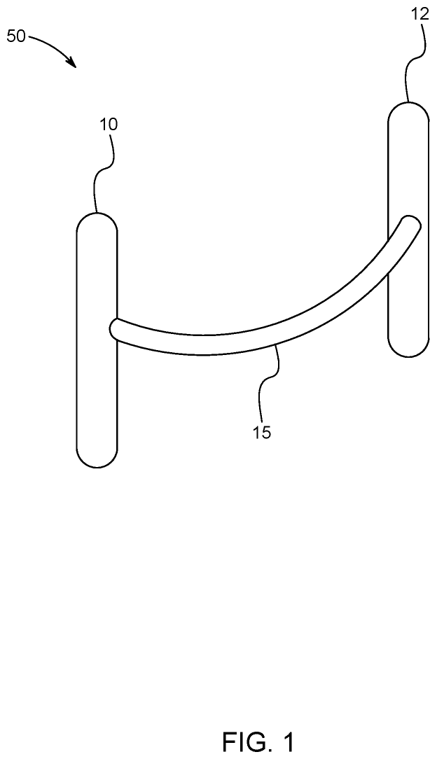

FIG. 1 illustrates a zoomed-in view of a flag-mounting brace 50, according to an exemplary embodiment of the present general inventive concept.

The flag-mounting brace 50 may include a first anchor 10 and a second anchor 12. A horizontal brace 15 may extend horizontally between the first anchor 10 and the second anchor 12. Preferably, this horizontal brace 15, the first anchor 10, and the second anchor 12 may be constructed of flexible material to facilitate placement of anchors through holes provided in a construction sign.

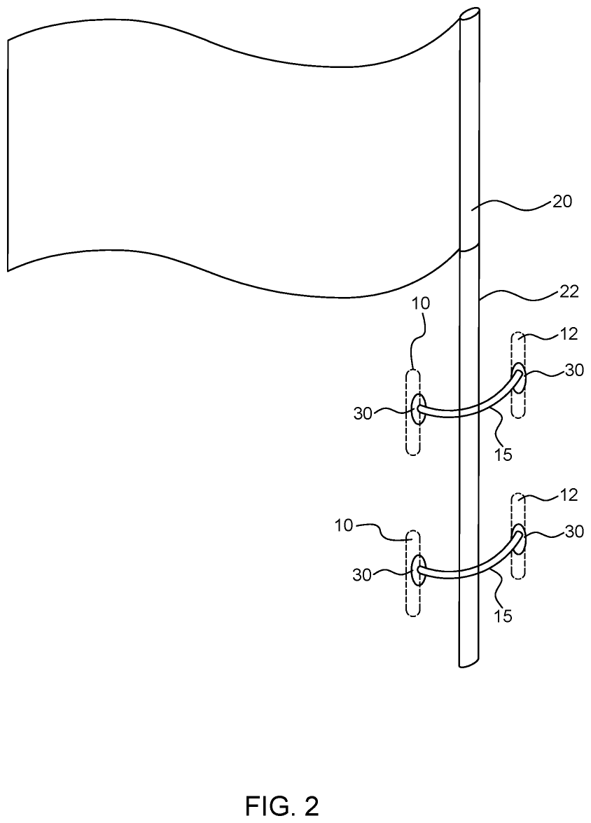

FIG. 2 illustrates a side perspective view of the flag-mounting brace 50 disposed around a flag 20 as disposed against a surface, according to an exemplary embodiment of the present general inventive concept.

Referring to FIG. 2, a flag 20 is shown with a short flag pole 22. The flag 20 may be similar to flags used commonly on roadway construction signs. Holes 30 may be available on a construction sign. The flag-mounting brace 50 according to the present invention is shown with the first anchor 10 and the second anchor 12 inserted through the holes 30. Once the first anchor 10 and the second anchor 12 are inserted the horizontal brace 15 may extend outwardly away from the sign and a user may insert the short flag pole 22 between the brace 15 and the sign to vertically mount the flag 20 in a stationary position. Once in a stationary position the flag 20 may be secured with the brace 50 and may be removed upon completion of the project.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A flag mounting brace, comprising:
a horizontal brace;
a first anchor disposed on a first end of the horizontal brace to removably connect to at least a portion of a sign; and
a second anchor disposed on a second end of the horizontal brace to removably connect to at least another portion of the sign.

2. The flag mounting brace of claim 1, wherein the horizontal brace deforms at least partially in response to a force applied thereupon.

3. The flag mounting brace of claim 1, wherein the horizontal brace prevents a flag from falling in response to insertion of the flag between the sign and the horizontal brace.

4. The flag mounting brace of claim 1, wherein the first anchor deforms at least partially in response to a force applied thereupon.

5. The flag mounting brace of claim 1, wherein the second anchor deforms at least partially in response to a force applied thereupon.
